(19) United States
(12) Patent Application Publication
(10) Pub. No.: US 2025/0387754 A1
(43) Pub. Date: Dec. 25, 2025

(54) REVERSE OSMOSIS FILTRATION SYSTEM

(71) Applicant: DELTA FAUCET COMPANY, Indianapolis, IN (US)

(72) Inventor: Joshua Drew Wales, Indianapolis, IN (US)

(21) Appl. No.: 18/879,575

(22) PCT Filed: Jun. 29, 2023
(86) PCT No.: PCT/US2023/026646

§ 371 Date: Dec. 27, 2024

Related U.S. Application Data
(60) Provisional application No. 63/356,614, filed on Jun. 29, 2022.

(51) Int. Cl. B01D 61/08; B01D 61/12; C02F 1/44; C02F 101/32

(52) U.S. Cl. CPC B01D 61/08; B01D 61/12; C02F 1/441; B01D 2313/18; B01D 2313/48; C02F 2101/322; C02F 2201/005; C02F 2209/03; C02F 2209/10; C02F 2301/046; C02F 2303/16

(57) ABSTRACT

A reverse osmosis filtration system including automatic flushing of a filter membrane to prevent total dissolved solids TDS creep.

### CROSS-REFERENCE TO RELATED APPLICATION

The present application claims priority to U.S. Provisional Patent Application Ser. No. 63/356,614, filed Jun. 29, 2022, the disclosure of which is expressly incorporated herein by reference.

### BACKGROUND AND SUMMARY OF THE DISCLOSURE

The present invention relates generally to a reverse osmosis filtration system and, more particularly, to a reverse osmosis filtration system including automatic flushing of the filter membrane to prevent total dissolve solids (TDS) creep.

It is known to provide tankless reverse osmosis (RO) systems to provide point-of-use (POU) (e.g., faucet) filtered water for drinking and/or cooking. However, such conventional systems typically suffer from total dissolved solids (TDS) creep. TDS creep is known in the art as the rate at which dissolved solids migrate through the filter membrane of the RO system when it is stagnant.

In response to TDS creep, the user can flush the RO system before each use. However, this process can be inefficient, particularly with tankless RO systems. More particularly, due to the amount of contamination in typical tankless RO systems, it would take a relatively long time to purge out the water, thus negating both the convenience and the efficiency advantages of such tankless RO systems. Existing tankless RO systems may include various forms of automated flushing in an attempt to mitigate TDS creep, but to little effect.

The present invention relates to a reverse osmosis (RO) filtration system configured to flush out the dirty or concentrate side of the filter membrane with filtered water after use, such that both sides of the large surface area filter membrane are in equilibrium and there is no (or minimal) movement of contaminants across the membrane (i.e., TDS creep).

According to an illustrative embodiment of the present disclosure, a reverse osmosis filtration system includes a filter membrane including a concentrate side and a permeate side. The concentrate side of the filter membrane is in fluid communication with a tap water inlet. The permeate side of the filter membrane is configured to be in fluid communication with a faucet. A flush reservoir is in fluid communication with the permeate side of the filter membrane. A flush outlet valve is fluidly coupled intermediate the flush reservoir and the concentrate side of the filter membrane.

According to another illustrative embodiment of the present disclosure, a reverse osmosis filtration system includes a filter membrane including a concentrate side and a permeate side. The concentrate side of the filter membrane is in fluid communication with a tap water inlet and a waste drain. The permeate side of the filter membrane is configured to be in fluid communication with a faucet. A reservoir is in fluid communication with the permeate side of the filter membrane. An electrically operable control valve provides selective fluid communication from the permeate side of the filter membrane, to the waste drain or to the reservoir. A pump is fluidly coupled intermediate the tap water inlet and the concentrate side of the filter membrane. A controller is operably coupled to the control valve and to the pump.

According to a further illustrative embodiment of the present disclosure, a reverse osmosis filtration system includes a filter membrane including a concentrate side and a permeate side. A tap water inlet is in fluid communication with the concentrate side of the filter membrane. A tap water inlet valve is fluidly coupled intermediate the tap water inlet and the concentrate side of the filter membrane. A waste drain is in fluid communication with the concentrate side of the filter membrane. An unpressurized reservoir is in fluid communication with the permeate side of the filter membrane. A flush valve is fluidly coupled intermediate the permeate side of the filter membrane and the unpressurized reservoir. A pressure sensor is operably coupled to the permeate side of the filter membrane. A controller is operably coupled to the tap water inlet valve, the flush valve and the pressure sensor.

According to another illustrative embodiment, a reverse osmosis filtration system includes a tap water inlet, a first inlet water valve fluidly coupled downstream from the tap water inlet, and a pump fluidly coupled downstream from the tap water inlet valve. A filter membrane includes a concentrate side and a permeate side. A second inlet water valve includes an inlet fluidly coupled to the permeate side of the filter membrane, and an outlet fluidly coupled to the pump for supplying water from the second inlet water valve intermediate the first inlet water valve and the pump. A circulation loop is defined by the pump, the filter membrane and the second inlet water valve. A waste drain is fluidly coupled downstream from the concentrate side of the filter membrane. A controller is operably coupled to the first inlet water valve, the pump, and the second inlet water valve. Illustratively, a dilution reservoir may be provided in series within the circulation loop.

According to a further illustrative embodiment of the present disclosure, a reverse osmosis filtration system includes a tap water inlet, a first inlet water valve fluidly coupled to the tap water inlet, and a pump fluidly coupled downstream from the first inlet water valve. A filter membrane includes a concentrate side and a permeate side. A second inlet water valve includes an inlet fluidly coupled to the permeate side of the filter membrane, and an outlet fluidly coupled to the pump for supplying water from the second inlet water valve intermediate the first inlet water valve and the pump. The first inlet water valve and the second inlet water valve each comprise an electrically operable valve. A waste drain is fluidly coupled downstream from the concentrate side of the filter membrane. A controller is operably coupled to the first inlet water valve, the pump and the second inlet water valve. A dilution reservoir is fluidly coupled downstream from the permeate side of the filter membrane. The dilution reservoir illustratively includes a volatile organic compound filter.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIG. 1 is a diagrammatic view of an illustrative reverse osmosis filtration system in the form of a flushing only, zero pressure reservoir system;

FIG. 2 is a diagrammatic view of an illustrative reverse osmosis filtration system in the form of a flushing only, low pressure reservoir system;

FIG. 3 is a diagrammatic view of an illustrative reverse osmosis filtration system in the form of a true hybrid with a delivery pump system; and

FIG. 4 is a diagrammatic view of an illustrative reverse osmosis filtration system in the form of a true hybrid with a water on water tank system;

FIG. 5 is a diagrammatic view of an illustrative reverse osmosis filtration system in the form of a true hybrid, no pre-flushing system;

FIG. 6 is a diagrammatic view of an illustrative reverse osmosis filtration system in the form of a hybrid, osmotic backwashing (OBW) flushing system; and

FIG. 7 is a diagrammatic view of an illustrative reverse osmosis filtration system in the form of a pure tankless with flushing system.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention. In the following illustrative drawing figures, solid lines represent fluid lines or conduits, and broken lines represent electrical lines or wires.

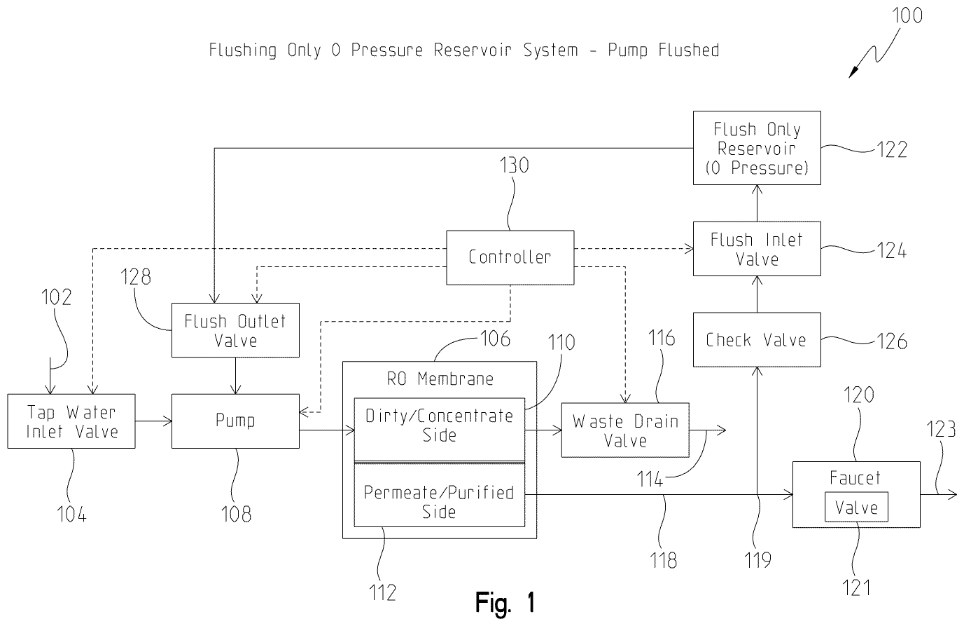

FIG. 1 shows an illustrative reverse osmosis (RO) filtration system 100 defined as a flushing only, zero pressure reservoir system that is pump flushed. More particularly, the system 100 is fluidly coupled to a conventional tap water source 102 via a tap water inlet valve 104, illustratively an electrically operable valve, such as a solenoid valve. A reverse osmosis (RO) filter membrane 106 is fluidly coupled upstream to the tap water inlet valve 104 via a pump 108. As is known, the illustrative filter membrane 106 includes a dirty or concentrate side 110 and a permeate or purified side 112. The filter membrane 106 may be a conventional reverse osmosis filer membrane of the type available from a variety of sources, such as Flowtech, Inc. of Kalamazoo, Michigan. The pump 108 may comprise a conventional electric water pump available from a variety of different sources.

The concentrate side 110 of the filter membrane 106 is fluidly coupled upstream to the pump 108 and the tap water inlet valve 104. The concentrate side 110 of the filter membrane 106 is fluidly coupled downstream to a waste drain 114 via a waste drain valve 116, illustratively an electrically operable valve, such as a solenoid valve. The permeate side 112 of the filter membrane 106 is fluidly coupled downstream to an outlet fluid line 118. The outlet fluid line 118 illustratively includes a T-junction or connector 119 providing fluid communication between the permeate side 112 of the filter membrane 106 and a fluid delivery device, such as a faucet 120, and a flush only reservoir 122.

The faucet 120 may be of conventional design as including a valve 121 controlling water flow to an outlet 123. The valve 121 may be a manual valve or an electrically operable valve (e.g., solenoid valve) in electrical communication with the controller 130. Illustratively, a sensor may be operably coupled to the faucet 120 to provide an indication to the controller 130 of water flow through the water outlet 123. Such a sensor may comprise, for example, a flow sensor or a position sensor coupled to the faucet valve 121.

The reservoir 122 is illustratively a tank or vessel of zero pressure (i.e., unpressurized). Further, the reservoir 122 is illustratively only large enough to hold a volume of water needed to provide a membrane flush cycle.

A flush inlet valve 124 is fluidly coupled intermediate the permeate side 112 of the filter membrane 106 and the reservoir 122. Illustratively, the flush inlet valve 124 is an electrically operable valve, such as a solenoid valve. An optional check valve 126 may be fluidly coupled upstream from the flush inlet valve 124. A flush outlet valve 128 is fluidly coupled intermediate the reservoir 122 and the pump 108. Again, the flush outlet valve 128 may be an electrically operable valve, such as a solenoid valve. The flush outlet valve 128 is configured to supply water from the reservoir 122 to the pump 108. In other illustrative embodiments, the flush outlet valve 128 may be a check valve which is typically a less expensive option than an electrically operable valve. The tap water from the water source 102 is at a higher pressure than the water pressure from the reservoir 122, thereby keeping the check valve closed during normal use.

Illustratively, a controller 130 is operably coupled to the electrically operable valves 104, 116, 124, 128 and the pump 108 to control operation thereof. More particularly, the controller 130 may include a processor or central processing unit (CPU) and a memory storing machine readable instructions executed by the processor.

During a normal water dispensing operation of the illustrative filtration system 100 (i.e., a normal dispensing mode), the tap water inlet valve 104 is open, and the pump 108 pushes water through the filter membrane 106 and the open faucet valve 121, such that water is dispensed from the outlet 123 of the faucet 120. At this time, the flush inlet valve 124, the flush outlet valve 128 and the waste drain valve 116 are illustratively closed. After water is dispensed from the faucet 120, the flush inlet valve 124 opens and the pump 108 continues pushing water through the filter membrane 106 to fill the reservoir 122.

After a predetermined time (e.g., five minutes) of no use of the faucet 120, the illustrative filtration system 100 enters a flushing operation (i.e., a flush mode). In this mode, the flush outlet valve 128 and the waste drain valve 116 are opened, and the pump 108 reactivates and pulls filtered water from the reservoir 122 to flush out the concentrate side 110 of the filter membrane 106. As noted above, the controller 130 illustratively controls operation of various electrical components of the filtration system 100 (e.g., the electrically operable valves 104, 116, 124, 128 and the pump 108).

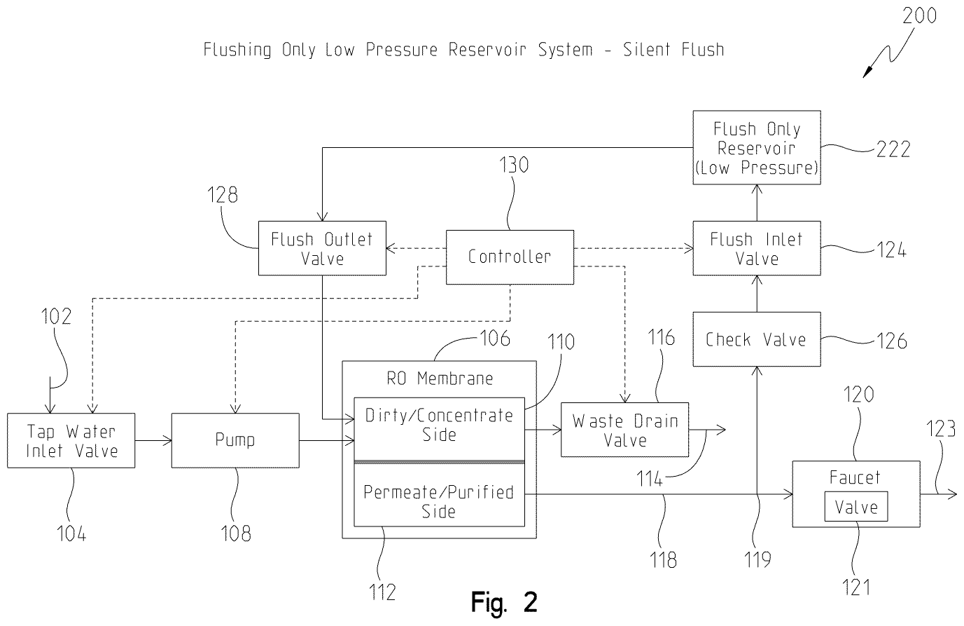

FIG. 2 shows an illustrative reverse osmosis (RO) filtration system 200 defined as a flushing only, low pressure reservoir system providing a silent flush. The illustrative filtration system 200 of FIG. 2 includes many features similar to the filtration system 100 of FIG. 1. As such, in the following description like reference numbers identify similar components.

The illustrative filtration system 200 includes a flush only reservoir 222 of low pressure water. Water pressure in the reservoir 222 is illustratively less than 20 psi, and preferably 10 psi or less. The reservoir water pressure is illustratively sufficient to gradually flush out the filter membrane 106 but does not need to be great enough for water delivery via the faucet 120. Illustratively, the reservoir 222 is only large enough to hold a volume of water needed to provide a membrane flush cycle. Illustratively, the flush outlet valve 128 is in direct fluid communication upstream with the concentrate side 110 of the filter membrane 106 (FIG. 2) as opposed to the pump 108 of the filtration system 100 (FIG. 1).

During operation of the illustrative filtration system 200, after water has been dispensed from the faucet 120 in the normal dispensing mode, the user closes the valve 121. Next, the controller 130 opens the flush inlet valve 124, and the pump 108 continues pushing water through the filter membrane 106 to fill the reservoir 222. At this time, the tap water inlet valve 104 is open, while the flush outlet valve 128 and the waste drain valve 116 are closed.

After a predetermined time (e.g., five minutes) of no use of the faucet 120, the controller 130 enters the flush mode, where the flush outlet valve 128 and the waste drain valve 116 are opened and the low pressure in the reservoir 222 slowly pushes water to flush out the concentrate side 110 of the filter membrane 106. Again, the controller 130 illustratively controls operation of various electrical components of the filtration system 200 (e.g., the electrically operable valves 104, 116, 124, 128 and the pump 108).

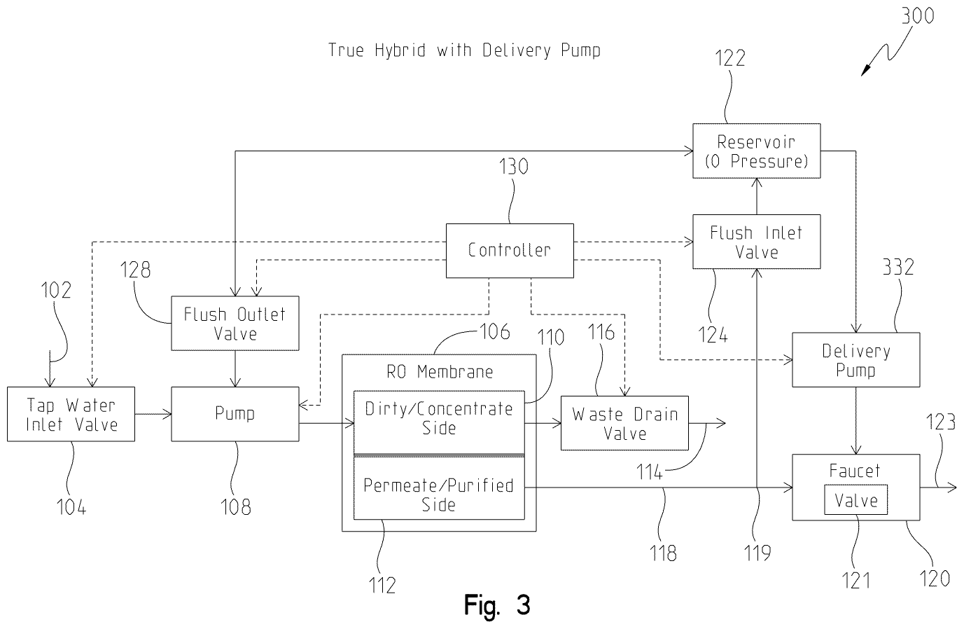

FIG. 3 shows an illustrative reverse osmosis (RO) filtration system 300 defined as a true hybrid system with a delivery pump system. The illustrative filtration system 300 of FIG. 3 includes many features similar to the filtration system 100 of FIG. 1. As such, in the following description like reference numbers identify similar components.

With further reference to FIG. 3, the illustrative reservoir 122 is twice as large as that needed for flush volume. A delivery pump 332 is fluidly coupled intermediate the reservoir 122 and the faucet 120.

During operation of the illustrative filtration system 300, after water has been dispensed from the faucet 120 in the normal dispensing mode, the user closes the faucet valve 121. Next, the controller 130 opens the flush inlet valve 124 and the pump 108 continues pushing water through the filter membrane 106 to fill the reservoir 122. At this time, the tap water inlet valve 104 is open, while the flush outlet valve 128 and the waste drain valve 116 are closed. After a predetermined time (e.g., five minutes) of no use of the faucet 120, the controller 130 enters the flush mode, where the flush outlet valve 128 and the waste drain valve 116 are opened and the supply pump 108 pulls water to flush out the concentrate side 110 of the filter membrane 106.

The delivery pump 332 may be activated by the controller 130 to supply water from the reservoir 122 to the faucet 120. More particularly, when the user draws water again via the faucet valve 121, water is initially supplied from the reservoir 122 to the faucet 120 via the delivery pump 332 so that no flushing is then needed. For dispenses smaller than the flush volume, this reduces flushing by at least twice. Again, the controller 130 illustratively controls operation of various electrical components of the filtration system 300 (e.g., the electrically operable valves 104, 116, 124, 128 and the pumps 108, 332).

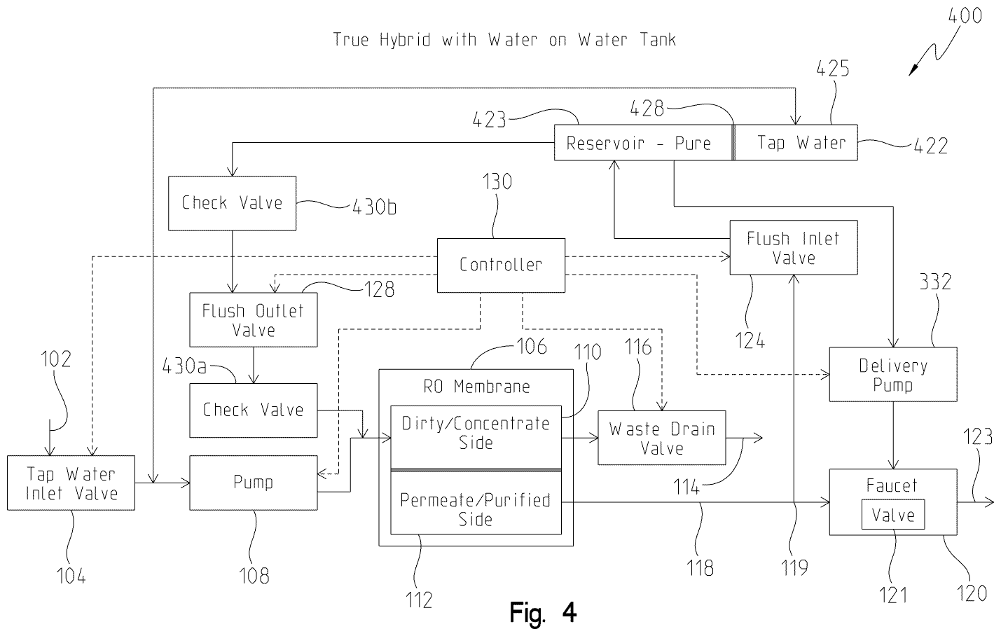

FIG. 4 shows an illustrative reverse osmosis (RO) filtration system 400 defined as a true hybrid with water on water tank system. The illustrative filtration system 400 of FIG. 4 includes many features similar to the filtration system 300 of FIG. 3. As such, in the following description like reference numbers identify similar components.

Illustratively, the reservoir 422 is twice as large as needed for a flush volume, and includes a filter (or pure) water portion 423 and a tap water portion 425. A flexible diaphragm 428 illustratively separates the filter water portion 423 from the tap water portion 425. The filter water portion 423 of the reservoir 422 is in fluid communication with the permeate side 112 of the filter membrane 106 via the flush inlet valve 124. The tap water portion 425 of the reservoir 422 is in fluid communication with the tap water inlet 102 via the tap water inlet valve 104. Check valves 430a and 430b may be provided to prevent backflow toward the flush outlet valve 128 and the reservoir 422, respectively.

After water has been dispensed from the faucet 120 in the normal dispensing mode, the user closes the faucet valve 121. Next, the controller 130 opens the flush inlet valve 124 opens and the pump 108 continues pushing water through the filter membrane 106 to fill the reservoir 422. At this time, the tap water inlet valve 104 is open, while the flush outlet valve 128 and the waste drain valve 116 are closed. Filtered water is pushed into the reservoir 422 from one side of the diaphragm 428 (i.e., the filter water portion 423), and tap water is pulled out of the reservoir 422 on the other side of the diaphragm 428 (i.e., the tap water portion 425) until full.

After a predetermined time (e.g., five minutes) of no use of the faucet 120, the controller 130 enters the flushing mode where the flush outlet valve 128, the waste drain valve 116 and the tap water inlet valve 104 are opened to allow tap water to push into the reservoir 422, pushing filtered water out to flush the concentrate side 110 of the filter membrane 106 and to the drain 114. More particularly, the flush outlet valve 128 provides water to the concentrate side 110 of the membrane 106.

When the user draws water again via the faucet valve 121, water is initially supplied for the reservoir 422 via the pump 332 so that no flushing is needed. For dispenses smaller than flush volume, this system 400 reduces the flushing by at least twice. Again, the controller 130 illustratively controls operation of various electrical components of the filtration system 400 (e.g., the electrically operable valves 104, 116, 124, 128 and the pumps 108, 332).

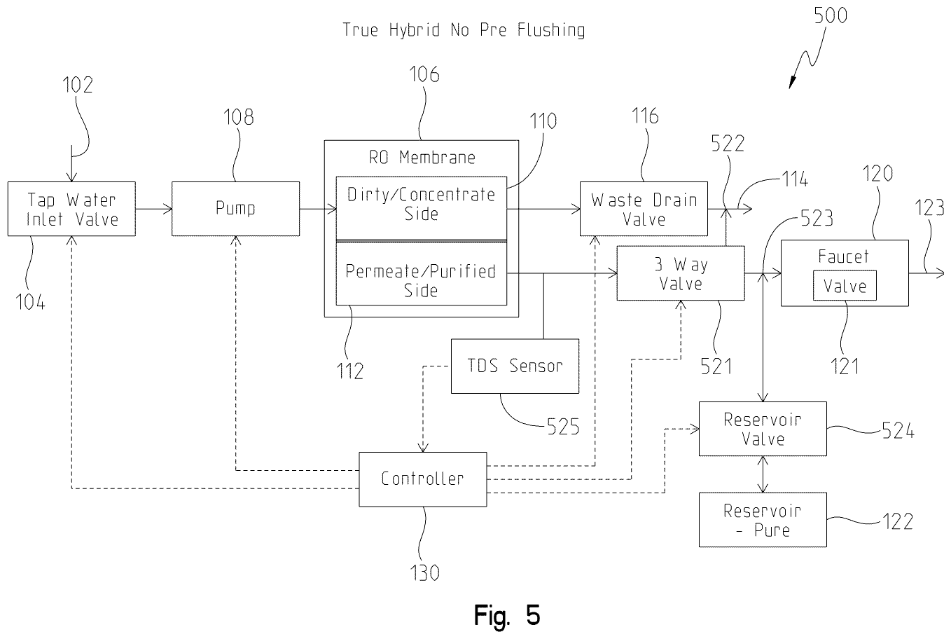

FIG. 5 shows an illustrative reverse osmosis (RO) filtration system 500 defined as a true hybrid, no pre-flushing system. The illustrative filtration system 500 of FIG. 5 includes many features similar to the filtration system 400 of FIG. 4. As such, in the following description like reference numbers identify similar components.

As shown in FIG. 5, a control valve 521 (such as a three-way valve) is fluidly coupled to the filter membrane 106. The control valve 521 is illustratively an electrically operable valve in electrical communication with the controller 130. More particularly, the illustrative three-way valve 521 includes an inlet fluidly coupled upstream to the permeate side 112 of the filter membrane 106, a first outlet fluidly coupled downstream to the waste drain 114 via a T-junction or connector 522, and a second outlet fluidly coupled downstream to a T-junction or connector 523 which, in turn, is fluidly coupled to the faucet 120 and the reservoir 122 (via a reservoir valve 524). The reservoir valve 524 may be an electrically operable valve, such as a solenoid valve, operably coupled to the controller 130.

Illustratively, the reservoir 122 is as large as needed to provide sufficient water until contaminated water has drained (e.g., about 1 quart). Illustratively, the reservoir 122 is pressurized. Instead of a pressurized reservoir 122, a zero pressure reservoir and a delivery pump could be used.

After a user stops dispensing water in the normal dispensing mode and closes the valve 121 of the faucet 120, the controller 130 opens the reservoir valve 524 and instructs the pump 108 to keep running until the reservoir 122 is full. Illustratively, a water level sensor (e.g., a float sensor or electrical contact) may be operably coupled to the reservoir 122 to provide a signal to the controller 130 indicative of water volume within the reservoir 122. At this time, the tap water inlet valve 104 is open, while the waste drain valve 116 is closed. If enough time has elapsed of no water flow through the faucet 120, the water in the filter membrane 106 may be contaminated by a total dissolved solids (TDS) creep before the user dispenses water again. In response, the controller 130 enters the flush mode where the user is supplied with water from the reservoir 122 through open reservoir valve 524, and the three-way valve 521 directs water from the filter membrane 106 to the drain 114 until it is clean enough for use.

An optional TDS sensor 525 could be used to adjust the amount of water diverted to the drain 114. The TDS sensor 525 may be of conventional design for measuring the amount of total dissolved solids (TDS) in water. The TDS sensor 525 is fluidly coupled intermediate the permeate side 112 of the filter membrane 106 and the 3-way valve 521, and is in electrical communication with the controller 130. Again, if the system 500 has not been inactive for long, water from the reservoir 122 could be used to augment initial water flow rate (a feature for the user). The controller 130 illustratively controls operation of, and/or receives input from, various electrical components of the filtration system 500 (e.g., the electrically operable valves 104, 116, 521, 524, the pump 108 and the TDS sensor 525).

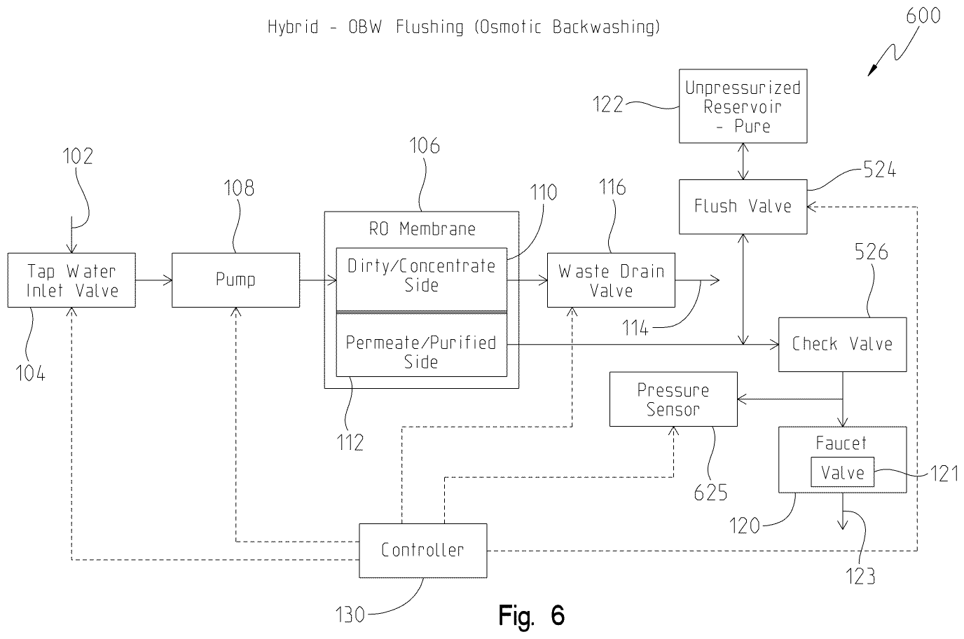

FIG. 6 shows an illustrative reverse osmosis (RO) filtration system 600 defined as a hybrid, osmotic backwashing (OBW) flushing system. The illustrative filtration system 600 of FIG. 6 includes many features similar to the filtration system 100 of FIG. 1. As such, in the following description like reference numbers identify similar components.

As shown in FIG. 6, a flush valve 524, illustratively an electrically operable valve such as a solenoid valve, is fluidly coupled intermediate the permeate side 112 of the filter membrane 106 and the reservoir 122. The reservoir 122 is illustratively unpressurized (i.e., zero pressure) and only as large as needed for flushing the filter membrane 106. A pressure sensor 625 is illustratively fluidly coupled intermediate the permeate side 112 of the filter membrane 106 and the faucet 120, and is in electrical communication with the controller 130. The pressure sensor 625 is of conventional design for measuring the pressure of water. A check valve 526 is illustratively positioned upstream from the pressure sensor 625.

After water has been dispensed from the faucet 120 during the normal mode, the user closes the faucet valve 121. Next, the controller 130 opens the water inlet valve 104 and the pump 108 continues pushing water through the filter membrane 106 until the reservoir 122 is full. At this time, the waste drain valve 116 is closed, and the flush valve 524 is open. Since the reservoir 122 has no captive air pressure, the pressure stays flat and then instantly builds when the reservoir 122 is full, thereby tripping pressure sensor 625.

In response to the pressure increase detected by the sensor 625, the controller 130 enters the flush mode by shutting off the pump 108 and closing the tap water inlet valve 104. The waste drain valve 116 is opened, and due to dynamic pressure on the concentrate side 110 of the filter membrane 106 and the lack of a pressurized reservoir on permeate side 112 of the filter membrane 106, no significant back pressure is created across the filter membrane 106 as the system 600 depressurizes. It should be appreciated that other methods could be employed to protect the membrane 106 from back pressure.

As the mechanical pressure drops, osmotic pressure takes over and pulls water from the permeate side 112 of the filter membrane 106 to the concentrate side 110 of the filter membrane 106. As this flow is concentration driven, it efficiently flushes the concentrate side 110 across the full membrane area. The check valve 526 illustratively maintains pressure at the pressure sensor 625 and the faucet 120. When the faucet valve 121 is opened, pressure at the faucet 120 drops and the controller 130 starts the pump 108 again. The cycle then repeats. Again, the controller 130 illustratively controls operation of, and/or receives input from, various electrical components of the filtration system 600 (e.g., the electrically operable valves 104, 116, 524, the pump 108 and the pressure sensor 625).

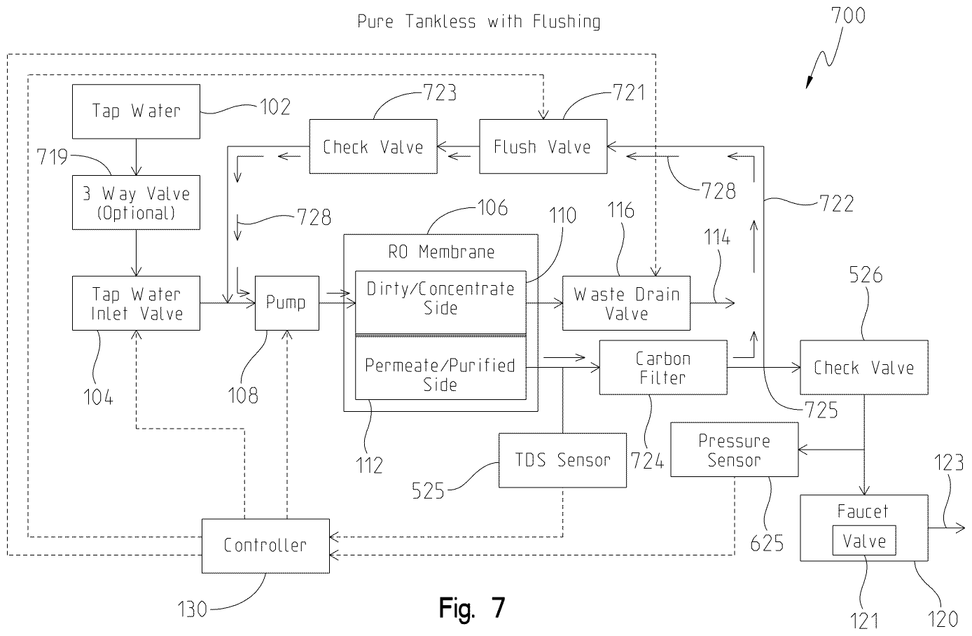

FIG. 7 is an illustrative reverse osmosis (RO) filtration system 700 defined as a pure tankless with flushing system. The system 700 of FIG. 7 includes many features similar to the filtration systems 500 and 600 of FIGS. 5 and 6, respectively. As such, like reference numbers identify similar components.

As shown in FIG. 7, the illustrative system 700 may include an optional three-way valve 719 in fluid communication with a conventional tap water source 102. The valve 719 may close water from being provided from the tap water source 102, for example, during maintenance. A first or tap water inlet valve 104 is fluidly coupled downstream from the three-way valve 719. A dilution reservoir 724 is illustratively fluidly coupled downstream from the filter membrane 106. As further detailed herein, the dilution reservoir 724 is configured to receive and store water passing through the filter membrane 106. The dilution reservoir 724 illustratively includes a volatile organic compound (VOC) filter. The VOC filter 724 is illustratively a conventional carbon filter configured to remove or reduce volatile organic compounds (VOCs) from water. A non-return or check valve 526 may be fluidly coupled intermediate the optional VOC filter 724 and the faucet 120.

A flush valve 721 is fluidly coupled downstream from the membrane filter 106 and the optional VOC filter 724. The flush valve 721 illustratively includes an electrically operable valve, such as a solenoid valve. A non-return or check valve 723 may be fluidly coupled downstream from the flush valve 721.

A circulating loop 722 is illustratively defined by the pump 108, the filter membrane 106, the VOC filter 724, the flush valve 721, and the non-return valve 723. As such, water from the outlet of the pump 108 is supplied to the filter membrane 106, where the filtered water passes through the VOC filter 724, to a branch or T-junction 725 to the flush valve 721, through the check valve 723 and back to the inlet of the pump 108 (see, e.g., arrows 728 representing circulating water flow). The VOC filter 724 downstream from the membrane 106 illustratively acts as a buffer of filtered water. By placing the VOC filter 724 within the circulating loop 722, it is flushed and refilled with water during each flush cycle.

An optional TDS sensor 525 is fluidly coupled intermediate the permeate side 112 of the filter membrane 106 and the VOC filter 724, and upstream from the flush valve 721. The TDS sensor 525 is in electrical communication with the controller 130. The TDS sensor 525 may be used to monitor water quality and provide feedback to the user via the controller 130. In other illustrative embodiments, the controller 130 may control operation of the system 700 (e.g., provide a flush cycle) in response to input from the TDS sensor 525.

Illustratively, a pressure sensor 625, such as a high pressure switch, may be fluidly coupled intermediate the permeate side 112 of the filter membrane 106 and the faucet 120, and is in electrical communication with the controller 130. The controller 130 may determine if water is flowing through the faucet 120 in response to water pressure detected by the pressure sensor 625. More particularly, when the valve 121 is open and water is flowing through the outlet 123, there is little or no water pressure detected by the pressure sensor 625. However, when the valve 121 is closed and water is not flowing through the faucet 120, then the valve 121 defines a restriction causing an increased water pressure detected by the pressure sensor 625.

In normal water dispensing operation of the illustrative filtration system 700 (i.e., normal dispensing mode) the tap water inlet valve 104 is open, and the pump 108 pushes water through the filter membrane 106, the VOC filter 724 and the open faucet valve 121, such that water is dispensed from the outlet 123 of the faucet 120. At this time, the flush valve 121 and the waste drain valve 116 are illustratively closed.

After a predetermined time (e.g., five minutes) of no use of the faucet 120, the water filtration system 700 enters the flushing operation (i.e., flush mode) where the controller 130, the illustrative filtration system 700 opens both the tap water inlet valve 104 and the inlet water valve 721, and activates the pump 108 for a predetermined time to mitigate TDS creep. This pulls in tap water from the inlet 102, pushes water through the RO filter membrane 106, through the VOC filter 724 and dilutes that incoming tap water with the volume of pure water going through the filter membrane 106, diluting the concentrate side 110 of the RO filter membrane 106 to the TDS of the tap water in a predetermined time (e.g., about 1 minute of flushing (wastes less than about 1 quart)). Illustratively, this reduces TDS creep by more than half. While TDS creep may still occur, it is reduced to the small volume of water in the filter membrane 106 itself.

When the user opens the faucet 120 to dispense water again, his/her first cup of water is relatively pure because it comes from the water in the VOC filter 724. The second cup of water is also relatively pure, still mostly coming from the relatively pure water sitting in the VOC filter 724. If the user pulls a larger volume of water, it is diluted with this water from the VOC filter 724, so again dramatically decreasing the impact of TDS creep. Without this water from the VOC filter 724, the TDS creep effect on water quality may still be too high. If the user only gets a cup of water (e.g., about 8 oz) then then concentrated water is pulled into the VOC filter 724, but a predetermined time later (e.g., 5 minutes) when the controller 130 operates in a flushing mode, water is recirculated back to the concentrate (dirty) side 110 of the filter membrane 106. Again, the controller 130 illustratively controls operation of, and/or receives input from, various electrical components of the filtration system 700 (e.g., the electrically operable valves 104, 116, 721, the pump 108, the TDS sensor 726 and the high pressure switch 727).

The following description further details advantages of an illustrative flushing system of the present disclosure over the prior art. If a VOC (e.g., carbon) filter 724 is positioned after the RO filter membrane 106 and is not in the flushing loop, the user receives a small amount of water (1 cup) and the TDS creep water goes into the carbon filter 724 and is not flushed out after use. As such, over multiple uses of small amounts of water, TDS accumulates in the downstream filter 724. Furthermore, the large VOC filter 724 readily absorbs any lead (and some other hazardous contaminants readily absorbed by VOC grade activated carbon) that do migrate through in the TDS, but since the filter 724 only sees the very small volume of contaminants that creep through in stagnation it can last a long time and provide exceptional lead removal performance (nearly complete lead removal, even after sitting overnight).

The recirculation of the system 700 also mitigates bacterial buildup in the VOC filter 724 and RO membrane 106 as the flushing also runs every 12 hours. This is helpful since carbon filters have large surface area and RO systems can have issues when left unused for days or weeks at a time. It also does all this without the large captive air storage tank of a tank based system which causes inefficiencies due to back pressure and create stagnant water that can grow bacteria and make water that smells when it sits out in a cup.

This is similarly true for VOCs which are partially removed by RO, but not well removed by an RO membrane 106. Placing the filter 724 after the RO membrane 106 prevents wasting the VOC filter 724 on the water that goes to the drain 114 from the RO membrane 106, Furthermore the RO membrane 106 does partially reject VOCs further prolonging the life of the VOC filter 724.

Although the invention has been described in detail with reference to certain preferred embodiments, variations and modifications exist within the spirit and scope of the invention as described and defined in the following claims.

1. A reverse osmosis filtration system comprising:
a filter membrane including a concentrate side and a permeate side;
wherein the concentrate side of the filter membrane is in fluid communication with a tap water inlet;
wherein the permeate side of the filter membrane is configured to be in fluid communication with a faucet;
a flush reservoir in fluid communication with the permeate side of the filter membrane; and
a flush outlet valve fluidly coupled intermediate the flush reservoir and the concentrate side of the filter membrane.

2.-12. (canceled)

13. A reverse osmosis filtration system comprising:
a filter membrane including a concentrate side and a permeate side;
the concentrate side of the filter membrane in fluid communication with a tap water inlet and a waste drain;
the permeate side of the filter membrane configured to be in fluid communication with a faucet;
a reservoir in fluid communication with the permeate side of the filter membrane;
an electrically operable control valve providing selective fluid communication from the permeate side of the filter membrane, to the waste drain or to the reservoir.
a pump fluidly coupled intermediate the tap water inlet and the concentrate side of the filter membrane; and
a controller operably coupled to the control valve and to the pump.

14. The reverse osmosis filtration system of claim 13, further comprising a tap water inlet valve fluidly coupled upstream from the pump.

15. The reverse osmosis filtration system of claim 13, further comprising a waste drain valve in fluid communication between the concentrate side of the filter membrane and the waste drain.

16. The reverse osmosis filtration system of claim 15, wherein the waste drain valve is an electrically operable valve in electrical communication with the controller.

17. The reverse osmosis filtration system of claim 13, further comprising a total dissolved solids sensor operably coupled to the permeate side of the filter membrane and in electrical communication with the controller.

18. The reverse osmosis filtration system of claim 13, further comprising an electrically operable reservoir valve positioned intermediate the control valve and in electrical communication with the controller.

19. The reverse osmosis filtration system of claim 13, wherein the control valve is a three-way valve.

20. A reverse osmosis filtration system comprising:
a filter membrane including a concentrate side and a permeate side;
a tap water inlet in fluid communication with the concentrate side of the filter membrane;
a tap water inlet valve fluidly coupled intermediate the tap water inlet and the concentrate side of the filter membrane;
a waste drain in fluid communication with the concentrate side of the filter membrane;
an unpressurized reservoir in fluid communication with the permeate side of the filter membrane;
a flush valve fluidly coupled intermediate the permeate side of the filter membrane and the unpressurized reservoir;
a pressure sensor operably coupled to the permeate side of the filter membrane; and
a controller operably coupled to the tap water inlet valve, the flush valve and the pressure sensor.

21. The reverse osmosis filtration system of claim 20, wherein the flush outlet valve and the flush inlet valve each comprise an electrically operable valve.

22. The reverse osmosis filtration system of claim 20, further comprising a pump fluidly coupled intermediate the tap water inlet and the flush outlet valve, and the concentrate side of the filter membrane, the pump operably coupled to the controller.

23. The reverse osmosis filtration system of claim 20, wherein the flush reservoir is unpressurized.

24. The reverse osmosis filtration system of claim 20, further comprising a waste drain valve in fluid communication between the concentrate side of the filter membrane and the waste drain, the waste drain valve operably coupled to the controller.

25. The reverse osmosis filtration system of claim 20, further comprising a faucet in fluid communication with the permeate side of the filter membrane.

26. A reverse osmosis filtration system comprising:
a tap water inlet;
an inlet water valve fluidly coupled downstream from the tap water inlet;
a pump fluidly coupled downstream from the first inlet water valve;
a filter membrane including a concentrate side and a permeate side;
a flush valve including an inlet fluidly coupled to the permeate side of the filter membrane, and an outlet fluidly coupled to the pump for supplying water from the flush valve intermediate the first inlet water valve and the pump;
a circulation loop defined by the pump, the filter membrane and the second inlet water valve;
a waste drain fluidly coupled downstream from the concentrate side of the filter membrane; and
a controller operably coupled to the first inlet water valve, the pump and the second inlet water valve.

27. The reverse osmosis filtration system of claim 26, wherein the first inlet water valve and the second inlet water valve each comprise an electrically operable valve.

28. The reverse osmosis filtration system of claim 26, further comprising a waste drain valve in fluid communication between the concentrate side of the filter membrane and the waste drain, the waste drain valve operably coupled to the controller.

29. The reverse osmosis filtration system of claim 26, further comprising a faucet fluidly coupled downstream from the permeate side of the filter membrane.

30. The reverse osmosis filtration system of claim 26, further comprising a dilution reservoir fluidly coupled downstream from the permeate side of the filter membrane.

31. The reverse osmosis filtration system of claim 30, wherein the dilution reservoir includes a volatile organic compound filter.

32. The reverse osmosis filtration system of claim 30, wherein the dilution reservoir is positioned within the circulation loop.

33. The reverse osmosis filtration system of claim 30, further comprising a total dissolved solids sensor fluidly coupled downstream from the permeate side of the filter membrane and operably coupled to the controller.

34. A reverse osmosis filtration system comprising:
a tap water inlet;
a first inlet water valve fluidly coupled downstream from the tap water inlet;
a pump fluidly coupled downstream from the first inlet water valve;
a filter membrane including a concentrate side and a permeate side;
a second inlet water valve including an inlet fluidly coupled to the permeate side of the filter membrane, and an outlet fluidly coupled to the pump for supplying water from the second inlet water valve intermediate the first inlet water valve and the pump;
wherein the first inlet water valve and the second inlet water valve each comprise an electrically operable valve;
a waste drain fluidly coupled downstream from the concentrate side of the filter membrane;
a controller operably coupled to the first inlet water valve, the pump, and the second inlet water valve; and
a dilution reservoir fluidly coupled downstream from the permeate side of the filter membrane.

35. The reverse osmosis filtration system of claim 34, further comprising a total dissolved solids sensor fluidly coupled downstream from the permeate side of the filter membrane and in electrical communication with the controller.

36. The reverse osmosis filtration system of claim 34, further comprising a faucet fluidly coupled downstream from the permeate side of the filter membrane.

37. The reverse osmosis filtration system of claim 34, further comprising a circulation loop defined by the pump, the filter membrane and the second inlet water valve.

38. The reverse osmosis filtration system of claim 37, wherein the dilution reservoir is positioned within the circulation loop.

39. The reverse osmosis filtration system of claim 34, further comprising a waste drain valve in fluid communication between the concentrate side of the filter membrane and the waste drain, the waste drain valve operably coupled to the controller.

40. The reverse osmosis filtration system of claim 34, wherein the dilution reservoir includes a volatile organic compound filter.
